(19) United States
(12) Patent Application Publication
(10) Pub. No.: US 2019/0115809 A1
(43) Pub. Date: Apr. 18, 2019

(54) Method for Connecting an End Ring to Conductor Strips of a Rotor of a Motor

(71) Applicant: Cheng Chang Machine Electronic Corp., Taichung City 428 (TW)

(72) Inventor: Chao-Chun Peng, Taichung City (TW)

(21) Appl. No.: 15/889,303

(22) Filed: Feb. 6, 2018

(30) Foreign Application Priority Data
Oct. 17, 2017 (TW) 106133696

(51) Int. Cl. H02K 15/00; H02K 15/02; H02K 17/16

(52) U.S. Cl. CPC H02K 15/0012; H02K 17/165; H02K 15/02

(57) ABSTRACT

In a method for connecting an end ring to conductor strips of a rotor of a motor, a core is provided by stacking silicon steel sheets. Each of the silicon steel sheets comprises an aperture and slots. Conductor strips are made with a cross-sectional shape corresponding to the slots and a length larger than that of the core. The conductor strips is inserted in the slots while locating the ends thereof out of the core. Two end rings are cast by using mold to wrap the ends of the conductor strips while keeping the molds away from the core, filling molten copper in the molds so that the molten copper partially melts the ends of the conductor strips, and cooling the molten copper via the molds so that the molten copper is cooled and hardened to provide the end rings. Then, the end rings is polished.

### BACKGROUND OF INVENTION

### 1. Field of Invention

The present invention relates to casting and, more particularly, to a method for connecting an end ring to conductor strips of a rotor of a motor.

### 2. Related Prior Art

In the design of a motor, change in the phase of an alternating circuit is used to generate a changing magnetic field. Alternatively, a changing peripheral magnetic field can be used to induce a rotor to generate a magnetic. Thus, there is no need for a coil around the rotor of a carbon brush, and the configuration of the rotor is simplified.

Referring to FIGS. 5 and 6, in a squirrel-cage rotor of an induction motor (single-phase or triple-phase), a core 91 includes conductor strips 92 inserted in stacked silicon steel sheets 911. Ends of the silicon steel sheets 911 are connected to two end rings 93. A changing peripheral magnetic field is used to generate a vortex and a magnetic force.

The end ring 93 is a laminate that includes stacked end-ring copper sheets 931 provided on the ends of the conductor strips 92 that stick out of the core 91. Each of end-ring copper sheets 931 includes slots (not numbered) for receiving the ends of the conductor strips 92. Thus, a proper number of end-ring copper sheets 931 can be stacked, i.e., the end ring 93 can be made of a proper thickness.

The fabrication of the end ring 93 is not without any problems. The end-ring copper sheets 931 might not be in tight contact with one another during the stacking. In practice, there are inevitably gaps. Hence, the quality of the end ring 93 is not good enough. Moreover, it takes a round of welding to connect each of the end-ring copper sheets 931 to a previous end-ring copper sheet 931 by welding. Therefore, the production of the end ring 93 is not efficient.

As disclosed in Taiwanese Patent No. 1539724, there has been an attempt to solve the foregoing problems by making the end ring and the conductor strips in one piece via casting. However, this is attempt has not been proven to be successful because molten copper heats, melts and deforms the silicon steel sheets 911 of the core 91 since the melting point of the silicon steel sheets 911 of the core 91 is much lower than that of the conductor strips 92. Thus, the silicon steel sheets 911 of the core 91 are ruined and cannot be used.

Moreover, the molten copper melts the silicon steel sheets 911 of the core 91 and produces tiny bubbles that cause poor conductivity. It is difficult to detect the tiny bubbles unless a precision instrument is used. A core 91 must only be abandoned or reworked if there are tiny bubbles on the surfaces of the silicon steel sheets 911.

The present invention is therefore intended to obviate or at least alleviate the problems encountered in prior art.

### SUMMARY OF INVENTION

It is an objective of the present invention to provide an efficient and effective method for connecting an end ring to conductor strips of a rotor of a motor.

To achieve the foregoing objective, the method includes the step of providing a core by stacking silicon steel sheets. Each of the silicon steel sheets comprises an aperture and slots. Conductor strips are made with a cross-sectional shape corresponding to the slots and a length larger than that of the core. The conductor strips is inserted in the slots while locating the ends thereof out of the core. Two end rings are cast by using mold to wrap the ends of the conductor strips while keeping the molds away from the core, filling molten copper in the molds so that the molten copper partially melts the ends of the conductor strips, and cooling the molten copper via the molds so that the molten copper is cooled and hardened to provide the end rings. Then, the end rings is polished.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a flow chart of method for connecting an end ring to conductor strips of a rotor of a motor according to the preferred embodiment of the present invention;

FIG. 2 is a perspective view of a core and conductor strips of a rotor of a motor made in the method shown in FIG. 1;

FIG. 3 is a perspective view of an end ring connected to the core and the conductor strips shown in FIG. 2;

FIG. 4 is an enlarged, partial and cut-away view of the rotor shown in FIG. 3;

FIG. 5 is a cross-sectional view of a conventional rotor of a motor; and

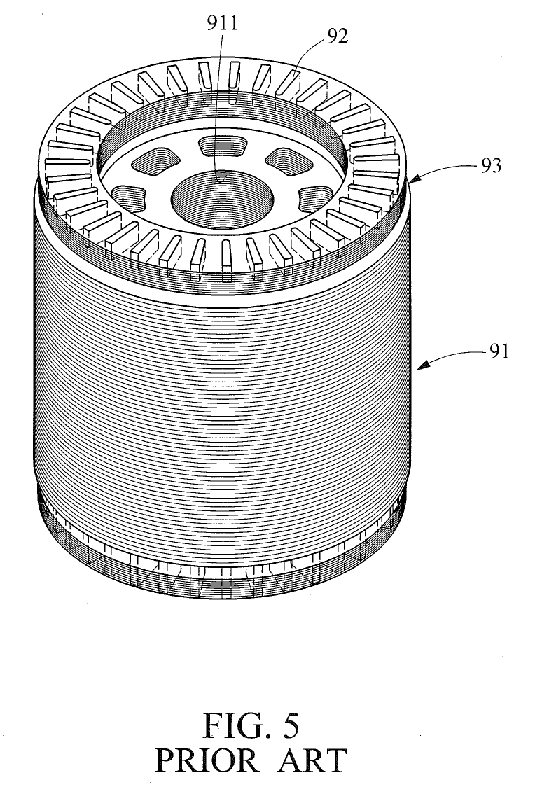

FIG. 6 is an enlarged, partial and cut-away view of the rotor shown in FIG. 5.

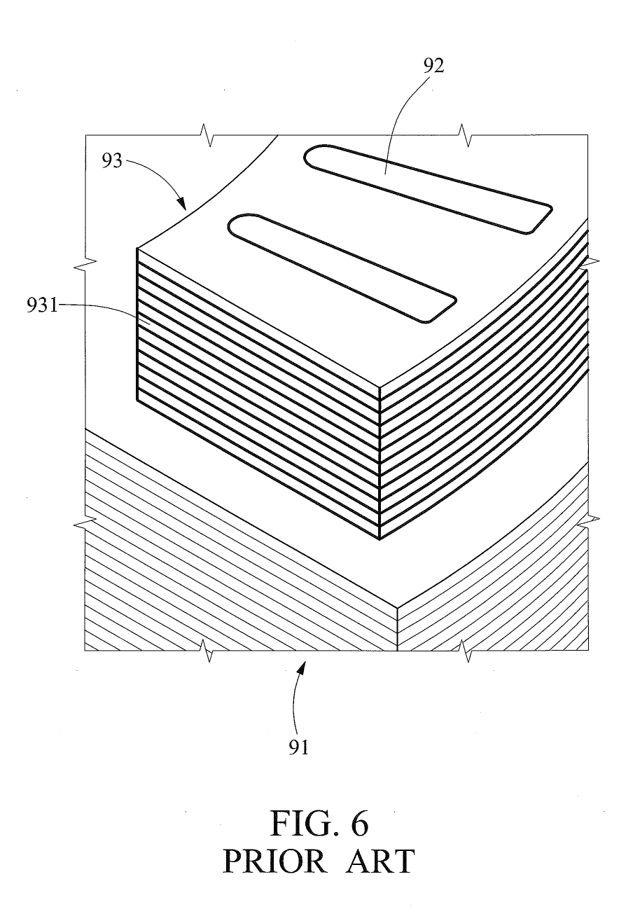

### DETAILED DESCRIPTION OF PREFERRED EMBODIMENT

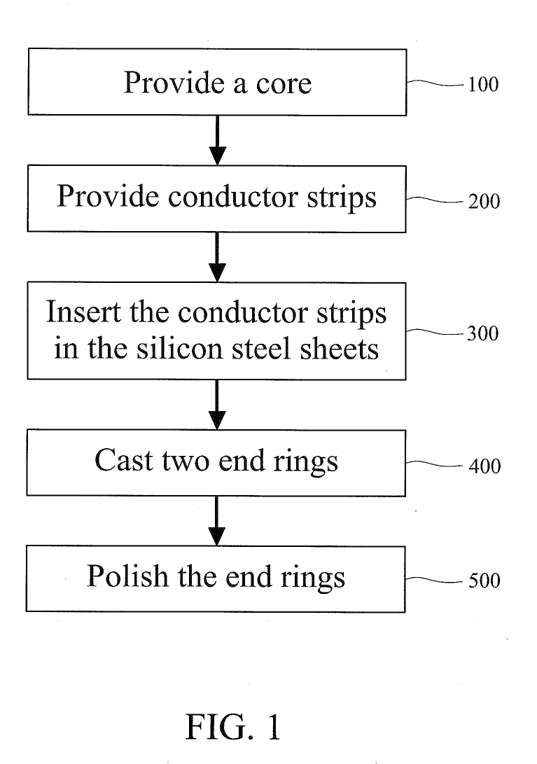

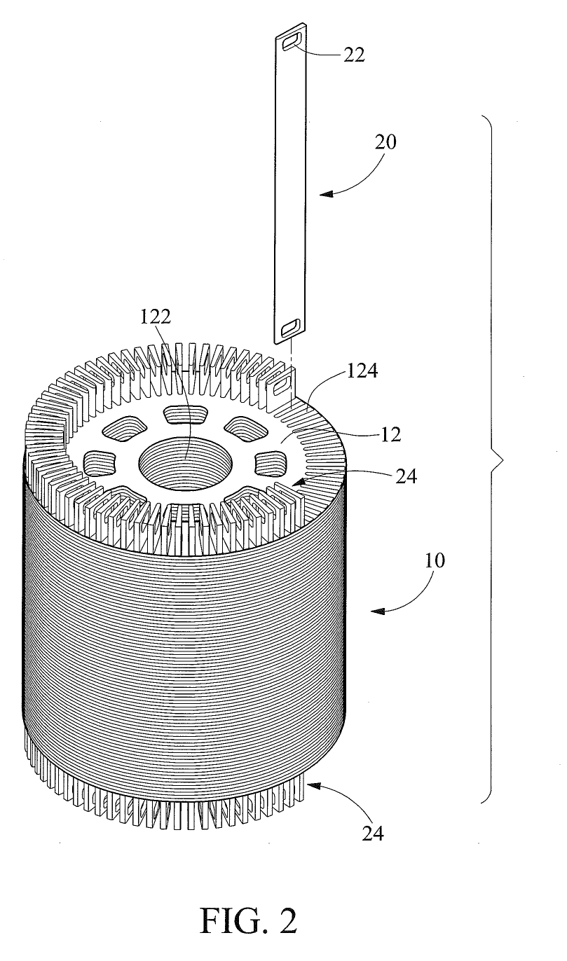

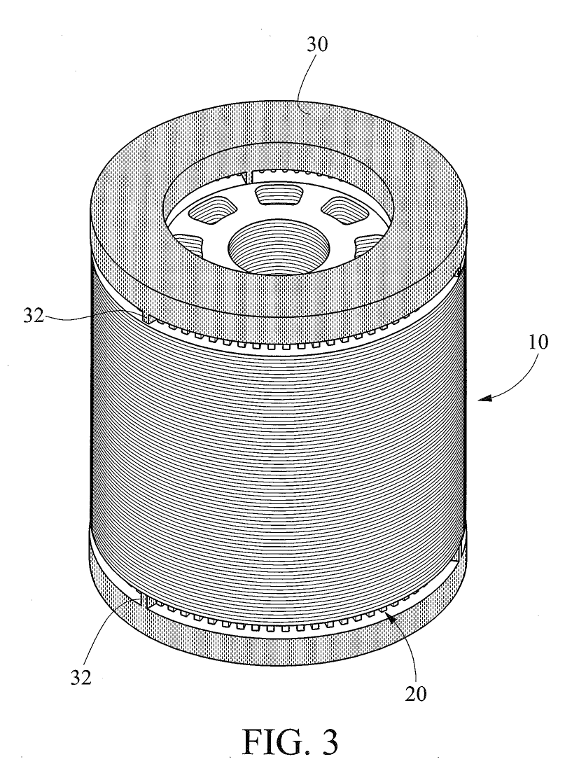

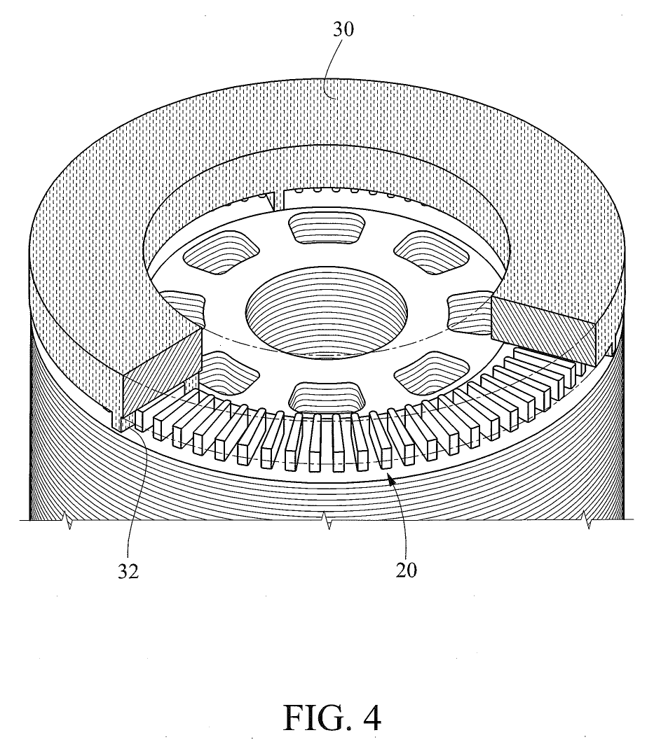

Referring to FIGS. 1 through 4, a method for connecting an end ring to conductor strips of a rotor of a motor will be described in detail.

At 100, a core 10 is made. To this end, a machine tool that can be but not limited to a punching machine and a cutting machine is used to make real circular silicon steel sheets 12. Each of the silicon steel sheets 12 includes an aperture 122 and several slots 124. The silicon steel sheets 12 are coaxially stacked to form the core 10 in the form of a column.

At 200, conductor strips 20 are made. To this end, a machine tool that can be but not limited to a punching machine and a cutting machine is used to make conductor strips 20. The cross-sectional shape of the conductor strips 20 are in compliance with the slots 124 of the silicon steel sheets 12. Each of the conductor strips 20 includes two bores 22, each in the vicinity of an end 24 thereof.

At 300, the conductor strips 20 are inserted in the silicon steel sheets 12. The conductor strips 20 are inserted in the slots 124 of the silicon steel sheets 12 of the core 10. The ends 24 and bores 222 of each of the conductor strips 20 are located out of the core 10.

At 400, two end rings 30 are cast. Molds (not shown) are used to wrap the ends 24 of the conductor strips 20. The molds are kept from the core 10. Molten copper is filled in the molds to cast the end rings 30. In the molds, the molten copper contacts the ends 24 of the conductor strips 20 and enters the bores 22, which are located near the ends 24 of the conductor strips 20. The casting is preferably centrifugal or vacuum casting to partially melt the ends 24 of the conductor strips 20. Thus, the surfaces of the ends 24 of the conductor strips 20 are reduced, and so is the exchange of heat of the molten copper with the conductor strips 20. Thus, the temperature of the molten copper will not be reduced considerably. The molten copper does not just wrap the ends 24 of the conductor strips 20. The molten copper is mixed with the partially molten ends 24 of the conductor strips 20. Hence, there will not be any gap between the molten copper and the partially molten ends 24 of the conductor strips 20 when they get cooled and hardened. Moreover, bubbles in the molten copper and impurities tend to be cast outward and collected because of the centrifugal force.

At 400, there is formed at least one positioning portion (not numbered). As discussed above, the molds wrap the ends 24 of the conductor strips 20 and are kept from the core 10. The molds provide channels lead to the core 10 from the interior thereof. Thus, a very small portion of the molten copper reaches two ends of the core 10 during the casting of the end rings 30. When the copper is cooled and harden, at least one positioning portion is formed between each of the ending rings 30 and a corresponding one of the ends of the core 10.

At 500, the end rings 30 are polished. The end rings 30 are polished to remove furs, bubbles and/or impurities.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A method for connecting an end ring to conductor strips of a rotor of a motor comprising the steps of:
(a) providing a core (10) by stacking silicon steel sheets (12) each of which comprises an aperture (122) and slots (124);
(b) providing conductor strips (20), wherein the conductor strips (20) comprises a cross-sectional shape corresponding to the slots (124) and a length larger than that of the core (10);
(c) inserting the conductor strips (20) in the slots (124) while locating the ends (24) thereof out of the core (10);
(d) casting two end rings (30) by using mold to wrap the ends (24) of the conductor strips (20) while keeping the molds away from the core (10), filling molten copper in the molds so that the molten copper partially melts the ends (24) of the conductor strips (20), and cooling the molten copper via the molds so that the molten copper is cooled and hardened to provide the end rings (30); and
(e) polishing the end rings (30).

2. The method according to claim 1, wherein the step (d) of casting the end rings (30) comprises the step of using centrifugal casting to cast the end rings (30).

3. The method according to claim 1, wherein the step (d) of casting the end rings (30) comprises the step of using vacuum casting to cast the end rings (30).

4. The method according to claim 1, wherein the step of providing the conductor strips (20) comprises the step of making each of the conductor strips (20) with two bores (22) near the ends (24).

5. The method according to claim 1, wherein the step (d) of casting the end rings (30) comprises the step of casting at least one positioning portion between each of the end rings (30) and a corresponding end of the core (10).

6. The method according to claim 5, wherein the step of casting the positioning portions comprises the step of making the molds with channels each of which lead to the corresponding end ring (30) from the corresponding end of the core (10).

7. The method according to claim 5, wherein the step of providing the conductor strips (20) comprises the step of making each of the conductor strips (20) with two bores (22) near the ends (24).
